(19) United States
(12) Patent Application Publication
(10) Pub. No.: US 2023/0112156 A1
(43) Pub. Date: Apr. 13, 2023

(54) METHOD AND SYSTEM FOR PROVIDING DYNAMIC WORKSPACE SCHEDULER

(71) Applicant: JPMorgan Chase Bank, N.A., New York, NY (US)

(72) Inventors: Parisa ZEHTABI, London (GB); Alberto POZANCO, Madrid (ES); Rui Manuel Ramos Teixeira Da SILVA, London (GB); Salwa Husam ALAMIR, Bournemouth (GB); Daniel BORRAJO, Pozuelo de Alarcon (ES); Mahmoud MAHFOUZ, London (GB); Daniele MAGAZZENI, London (GB); Maria Manuela VELOSO, New York, NY (US); Tracy RASCO, New York, NY (US); Jonathan R. HORN, London (GB); Amy BLACKWELL, Poole (GB); Debra HERSCHMANN, Bradenton, FL (US)

(73) Assignee: JPMorgan Chase Bank, N.A., New York, NY (US)

(21) Appl. No.: 17/450,609

(22) Filed: Oct. 12, 2021

(51) Int. Cl. G06Q 10/06

(52) U.S. Cl. CPC G06Q 10/06311

(57) ABSTRACT

A method for generating schedules for a group of persons within a common workspace is provided. The method includes: receiving a first user input that relates to employee preferences; receiving a second user input that relates to at least one manager preference; receiving a third user input that relates to business constraints; generating, based on the received first, second, and third user inputs, a respective schedule for each corresponding group member; and outputting each respective schedule to a user interface for display thereon. The method may also include generating a set of metrics that corresponds to the employee preferences.

### BACKGROUND

### 1. Field of the Disclosure

This technology generally relates to methods and systems for handling flexible working and office space optimization, and more particularly to methods and systems for maximizing a number of individuals co-located in a workspace for a given set of constraints while providing fairness and flexibility in scheduling and considering individual preferences.

### 2. Background Information

In a large organization, which may employ a large number of people, such as, for example, hundreds of thousands of people, maximizing the number of employees who can collaborate at any given time in a physical workspace while addressing their unique scheduling needs is important—i.e., fundamental to employee well-being and integral to the success of the organization. One key aspect for teams within such an organization is a rotational scheduling solution that could quickly and impartially consider constraints and produce a schedule instance.

In April 2021, a study by the Becker Friedman Institute for Economics at the University of Chicago found that leaders believe the opportunity to collaborate and innovate together is integral to sustained success, profitability and a strong organizational culture. These drivers are seen as essential to competitive advantage and growth. Co-locating team members is fundamental to meaningful collaboration, that is, team collaboration is viewed as optimal when team members are in the same space at the same time.

Accordingly, there is a need for a method to maximize a number of individuals co-located in a workspace for a given set of constraints while providing fairness and flexibility in scheduling.

### SUMMARY

The present disclosure, through one or more of its various aspects, embodiments, and/or specific features or sub-components, provides, inter alia, various systems, servers, devices, methods, media, programs, and platforms for maximizing a number of individuals co-located in a workspace for a given set of constraints while providing fairness and flexibility in scheduling.

According to an aspect of the present disclosure, a method for generating schedules for a plurality of persons within a common workspace is provided. The method is implemented by at least one processor. The method includes: receiving, by the at least one processor, a first user input that relates to at least one employee preference; receiving, by the at least one processor, a second user input that relates to at least one manager preference; receiving, by the at least one processor, a third user input that relates to at least one business constraint; generating, by the at least one processor based on the received first, second, and third user inputs, a respective schedule for each corresponding one of the plurality of persons; and outputting, by the at least one processor, each respective schedule to a user interface for display thereon.

The method may further include generating a set of metrics that corresponds to each of the at least one employee preference.

The set of metrics may include at least one from among a percentage of employee preferences that are satisfied by the generated schedules, a percentage of manager preferences that are satisfied by the generated schedules, a date-specific office utilization percentage, and a date-specific desk utilization percentage.

The first user input may include at least one from among a minimum number of days per week in-office, a maximum number of days per week in-office, at least one out-of-office date, and at least one preferred weekday in-office.

The second user input may include at least one from among a schedule duration and a respective list of employees associated with a corresponding working group.

The third user input may include at least one from among a respective number of desks allocated to a corresponding working group, a minimum number of days in-office, a maximum number of days in-office, and at least one out-of-office date associated with a particular employee.

The method may further include generating an explanation with respect to the schedules, and outputting the generated explanation to the user interface for display thereon.

The generating of the schedules may include applying an artificial intelligence (AI) algorithm that implements a technique based on planning, scheduling, and constraint reasoning in order to model the received user inputs in order to generate the schedules.

According to another aspect of the present disclosure, a computing apparatus for generating schedules for a plurality of persons within a common workspace is provided. The computing apparatus includes a processor and a communication interface coupled to the processor. The processor is configured to: receive, via the communication interface, a first user input that relates to at least one employee preference; receive, via the communication interface, a second user input that relates to at least one manager preference; receive, via the communication interface, a third user input that relates to at least one business constraint; generate, based on the received first, second, and third user inputs, a respective schedule for each corresponding one of the plurality of persons; and output, via the communication interface, each respective schedule to a user interface for display thereon.

The processor may be further configured to generate a set of metrics that corresponds to each of the at least one employee preference.

The set of metrics may include at least one from among a percentage of employee preferences that are satisfied by the generated schedules, a percentage of manager preferences that are satisfied by the generated schedules, a date-specific office utilization percentage, and a date-specific desk utilization percentage.

The first user input may include at least one from among a minimum number of days per week in-office, a maximum number of days per week in-office, at least one out-of-office date, and at least one preferred weekday in-office.

The second user input may include at least one from among a schedule duration and a respective list of employees associated with a corresponding working group.

The third user input may include at least one from among a respective number of desks allocated to a corresponding working group, a minimum number of days in-office, a maximum number of days in-office, and at least one out-of-office date associated with a particular employee.

The processor may be further configured to generate an explanation with respect to the schedules, and to output the generated explanation to the user interface for display thereon.

The processor may be further configured to generate the schedules by applying an artificial intelligence (AI) algorithm that implements a technique based on planning, scheduling, and constraint reasoning in order to model the received user inputs in order to generate the schedules.

According to yet another aspect of the present disclosure, a non-transitory computer readable storage medium storing instructions for generating schedules for a plurality of persons within a common workspace is provided. The storage medium includes executable code which, when executed by a processor, causes the processor to: receive a first user input that relates to at least one employee preference; receive a second user input that relates to at least one manager preference; receive a third user input that relates to at least one business constraint; generate, based on the received first, second, and third user inputs, a respective schedule for each corresponding one of the plurality of persons; and output each respective schedule to a user interface for display thereon.

When executed by the processor, the executable code may further cause the processor to generate a set of metrics that corresponds to each of the at least one employee preference.

The set of metrics may include at least one from among a percentage of employee preferences that are satisfied by the generated schedules, a percentage of manager preferences that are satisfied by the generated schedules, a date-specific office utilization percentage, and a date-specific desk utilization percentage.

When executed by the processor, the executable code may further cause the processor to generate an explanation with respect to the schedules, and to output the generated explanation to the user interface for display thereon.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for maximizing a number of individuals co-located in a workspace for a given set of constraints while providing fairness and flexibility in scheduling.

FIG. 4 is a flowchart of an exemplary process for implementing a method for maximizing a number of individuals co-located in a workspace for a given set of constraints while providing fairness and flexibility in scheduling.

FIG. 5 is a screenshot of a user interface displaying a set of metrics generated while executing a method for maximizing a number of individuals co-located in a workspace for a given set of constraints while providing fairness and flexibility in scheduling, according to an exemplary embodiment.

FIG. 6 is a block diagram of a system architecture that is configured to execute a method for maximizing a number of individuals co-located in a workspace for a given set of constraints while providing fairness and flexibility in scheduling, according to an exemplary embodiment.

FIG. 7 is a screenshot of a user interface displaying a home page and a prompt for loading a set of preferences that is generated while executing a method for maximizing a number of individuals co-located in a workspace for a given set of constraints while providing fairness and flexibility in scheduling, according to an exemplary embodiment.

FIG. 8 is a screenshot of a user interface displaying a set of schedules that is generated while executing a method for maximizing a number of individuals co-located in a workspace for a given set of constraints while providing fairness and flexibility in scheduling, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

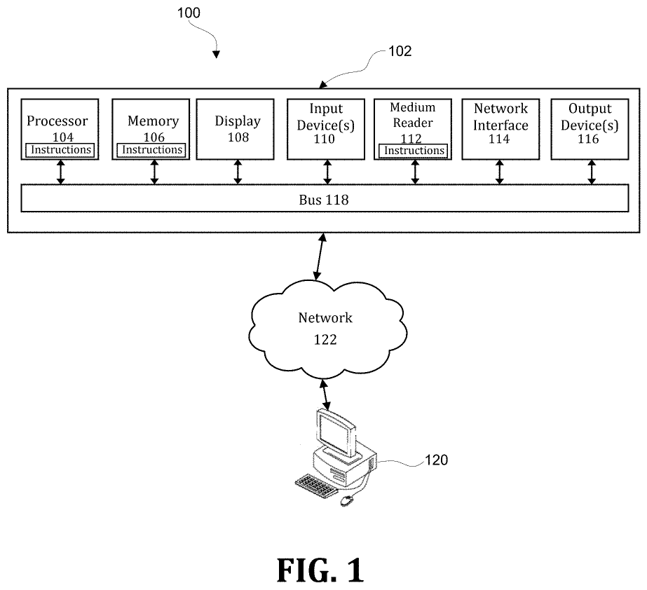

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for maximizing a number of individuals co-located in a workspace for a given set of constraints while providing fairness and flexibility in scheduling.

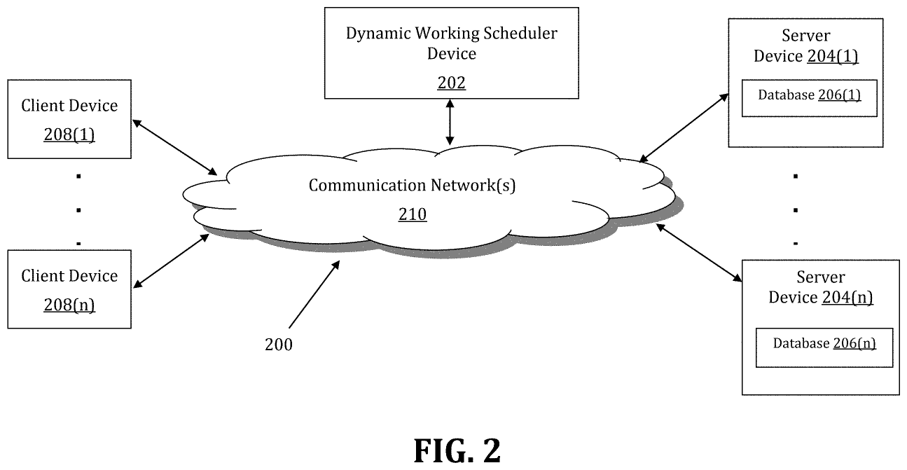

Referring to FIG. 2, a schematic of an exemplary network environment 200 for implementing a method for maximizing a number of individuals co-located in a workspace for a given set of constraints while providing fairness and flexibility in scheduling is illustrated. In an exemplary embodiment, the method is executable on any networked computer platform, such as, for example, a personal computer (PC).

The method for maximizing a number of individuals co-located in a workspace for a given set of constraints while providing fairness and flexibility in scheduling may be implemented by a Dynamic Working Scheduler (DWS) device 202. The DWS device 202 may be the same or similar to the computer system 102 as described with respect to FIG. 1. The DWS device 202 may store one or more applications that can include executable instructions that, when executed by the DWS device 202, cause the DWS device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DWS device 202 itself, may be located in virtual server(s) running in a cloud-based computing environment rather than being tied to one or more specific physical network computing devices. Also, the application(s) may be running in one or more virtual machines (VMs) executing on the DWS device 202. Additionally, in one or more embodiments of this technology, virtual machine(s) running on the DWS device 202 may be managed or supervised by a hypervisor.

In the network environment 200 of FIG. 2, the DWS device 202 is coupled to a plurality of server devices 204(1)-204(n) that hosts a plurality of databases 206(1)-206(n), and also to a plurality of client devices 208(1)-208(n) via communication network(s) 210. A communication interface of the DWS device 202, such as the network interface 114 of the computer system 102 of FIG. 1, operatively couples and communicates between the DWS device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DWS device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DWS devices that efficiently implement a method for maximizing a number of individuals co-located in a workspace for a given set of constraints while providing fairness and flexibility in scheduling.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DWS device 202 may be a standalone device or integrated with one or more other devices or apparatuses, such as one or more of the server devices 204(1)-204(n), for example. In one particular example, the DWS device 202 may include or be hosted by one of the server devices 204(1)-204(n), and other arrangements are also possible. Moreover, one or more of the devices of the DWS device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DWS device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to office space and equipment and data that relates to personnel schedules.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DWS device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DWS device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DWS device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DWS device 202, the server devices 204(1)-204(n), or the client devices 208(1)-208(n), for example, may be configured to operate as virtual instances on the same physical machine. In other words, one or more of the DWS device 202, the server devices 204(1)-204(n), or the client devices 208(1)-208(n) may operate on the same physical device rather than as separate devices communicating through communication network(s) 210. Additionally, there may be more or fewer DWS devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

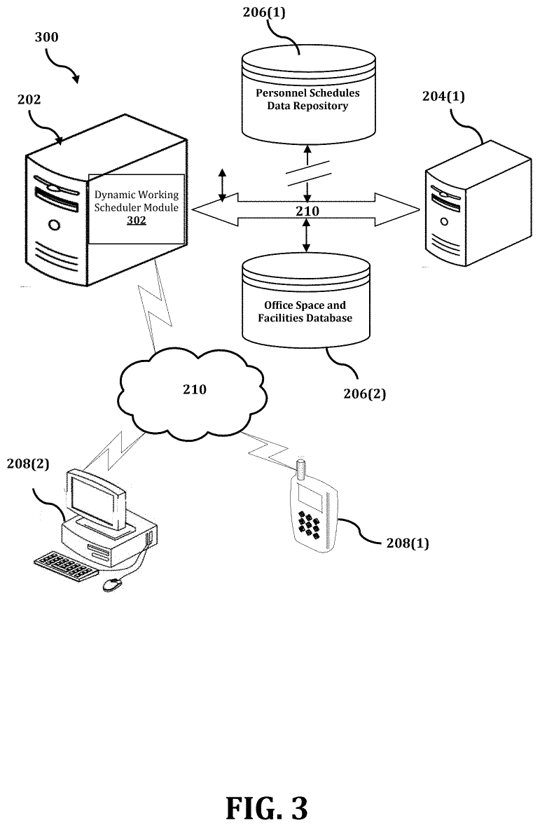

The DWS device 202 is described and illustrated in FIG. 3 as including a dynamic working scheduler module 302, although it may include other rules, policies, modules, databases, or applications, for example. As will be described below, the dynamic working scheduler module 302 is configured to implement a method for maximizing a number of individuals co-located in a workspace for a given set of constraints while providing fairness and flexibility in scheduling.

An exemplary process 300 for implementing a mechanism for maximizing a number of individuals co-located in a workspace for a given set of constraints while providing fairness and flexibility in scheduling by utilizing the network environment of FIG. 2 is illustrated as being executed in FIG. 3. Specifically, a first client device 208(1) and a second client device 208(2) are illustrated as being in communication with DWS device 202. In this regard, the first client device 208(1) and the second client device 208(2) may be “clients” of the DWS device 202 and are described herein as such. Nevertheless, it is to be known and understood that the first client device 208(1) and/or the second client device 208(2) need not necessarily be “clients” of the DWS device 202, or any entity described in association therewith herein. Any additional or alternative relationship may exist between either or both of the first client device 208(1) and the second client device 208(2) and the DWS device 202, or no relationship may exist.

Further, DWS device 202 is illustrated as being able to access a personnel schedules data repository 206(1) and an office space and facilities database 206(2). The dynamic working scheduler module 302 may be configured to access these databases for implementing a method for maximizing a number of individuals co-located in a workspace for a given set of constraints while providing fairness and flexibility in scheduling.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DWS device 202 via broadband or cellular communication. Of course, these embodiments are merely exemplary and are not limiting or exhaustive.

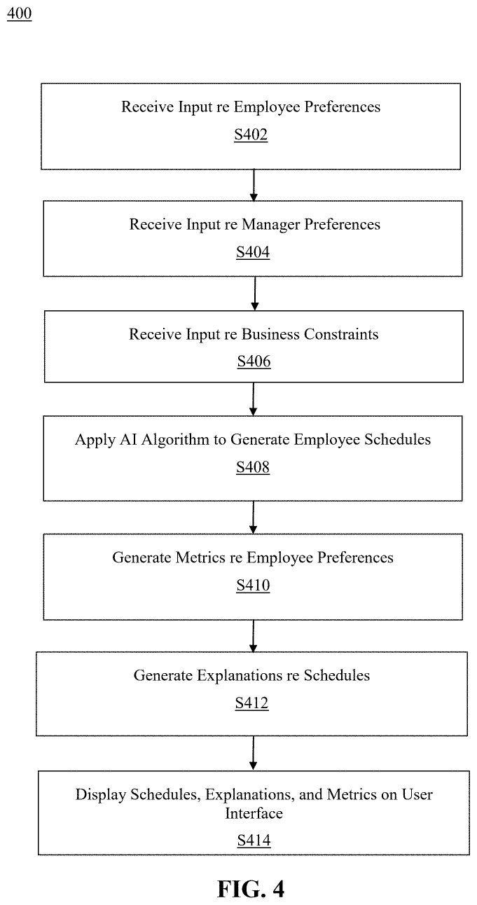

Upon being started, the dynamic working scheduler module 302 executes a process for maximizing a number of individuals co-located in a workspace for a given set of constraints while providing fairness and flexibility in scheduling. An exemplary process for maximizing a number of individuals co-located in a workspace for a given set of constraints while providing fairness and flexibility in scheduling is generally indicated at flowchart 400 in FIG. 4.

In process 400 of FIG. 4, at step S402, the dynamic working scheduler module 302 receives a first user input that relates to one or more employee preferences with respect to an individual employee's work schedule, i.e., preferences that are specific to a particular employee. In an exemplary embodiment, the employee preferences may include any one or more of a minimum number of days per week in-office, a maximum number of days per week in-office, at least one out-of-office date, and at least one preferred weekday in-office.

At step S404, the dynamic working scheduler module 302 receives a second user input that relates to manager preferences with respect to work schedules for a group or a team. In an exemplary embodiment, the manager preferences may include any one or more of a schedule duration and a respective list of employees associated with a corresponding working group or team.

At step S406, the dynamic working scheduler module 302 receives a third user input that relates to business constraints with respect to work schedules for a group or a team. In an exemplary embodiment, the business constraints may include any one or more of a respective number of desks allocated to a corresponding location, working group or team, a minimum number of days in-office, a maximum number of days in-office, and at least one out-of-office date associated with a particular employee.

At step S408, the dynamic working scheduler module 302 generates a respective schedule for each member of a particular group or team based on the inputs received in steps S402, S404, and S406. In an exemplary embodiment, the generating of the schedules is performed by applying an artificial intelligence (AI) algorithm that implements a technique based on planning, scheduling, and constraint reasoning in order to model the received user inputs in order to generate the schedules. Further, the model may be a mixed integer linear programming (MILP) model. In an exemplary embodiment, the MILP model may implement a machine learning technique based on historical schedule data to enhance a quality of the schedule generation. The MILP model may also implement a machine learning technique that enable the AI algorithm to learn from actual attendance data and provide feedback to the dynamic working scheduler module 302. For example, the actual attendance data may be obtained by using data that relates to badge swipes at turnstiles upon entry and exit by employees at office locations.

At step S410, the dynamic working scheduler module 302 generates a set of metrics that 1) relates to the schedules generated in step S408 and 2) corresponds to the employee preferences received as inputs in step S402. In an exemplary embodiment, the set of metrics may include any one or more of a percentage of employee preferences that are satisfied by the generated schedules, a percentage of manager preferences that are satisfied by the generated schedules, a date-specific office utilization percentage, and a date-specific desk utilization percentage.

At step S412, the dynamic working scheduler module 302 generates one or more explanations with respect to the generated schedules. In an exemplary embodiment, the explanations are generated in order to account for reasons why certain employee preferences are not honored in a particular schedule.

At step S414, the dynamic working scheduler module 302 outputs the schedules, metrics, and explanations to a user interface for display thereon. In an exemplary embodiment, the user interface may be displayed on computer screens of various employees and/or members of a particular group or team in order to provide a notification as to the upcoming work schedules and also to show the team members that the schedule is intended to maximize fairness and flexibility in scheduling within the known constraints.

In an exemplary embodiment, the present disclosure provides methods and systems for maximizing a number of individuals co-located in a workspace for a given set of constraints while providing fairness and flexibility in scheduling. In this context, flexible working refers to hybrid in-office schedules, which is different from the traditional five-day, in-office work week. Employees may prefer non-traditional in-office work schedules to meet personal or family needs. While rotational in-office scheduling helps meet office space optimization needs, one benefit of a flexible work arrangement for employees is a work/life balance that leads to increased job satisfaction, employee morale, and motivation. In an exemplary embodiment, in addition to employees, the number of individuals co-located in a workspace may include non-employees, such as clients, investors, or visitors. In this aspect, especially when a particular workspace is hosting an investor event or a client event, there is a need to account for the expected attendees.

In a large organization that may employ hundreds of thousands of people, maximizing the number of employees who can collaborate at any given time in a physical workspace while addressing their unique scheduling needs is important, i.e., fundamental to employee well-being and integral to the success of the organization. A key enabler for teams is a rotational scheduling solution that could quickly and impartially consider constraints and produce a schedule instance.

The present inventors have developed a tool for this purpose, based partly on input from user testing groups, with an objective of reflecting an intersection with workplace elements integral to both employee satisfaction and organizational livelihood, namely: collaboration, fairness and flexibility.

Collaboration: At least one study has found that leaders believe the opportunity to collaborate and innovate together is integral to sustained success, profitability and a strong organizational culture. These drivers are seen as essential to competitive advantage and growth. Co-locating team members is fundamental to meaningful collaboration, that is, team collaboration is viewed as optimal when team members are in the same space at the same time.

In a large organization, each team may be unique in its collaboration needs. Individuals can be members of multiple collaborating teams. In an exemplary embodiment, this notion is central to the behavior of the tool, which handles co-location through rotational scheduling based on collaboration needs, expressed as constraints, or preferences. For people working together on a project, the generated schedule seeks to book those individuals in the office on the same days.

Fairness: While teams are unique in their scheduling needs, individual team members also have individual preferences. A rotational scheduling tool that reasons in terms of fairness, ensuring for example, to distribute out-of-office Fridays evenly among staff for the planning period reflects fairness. In an exemplary embodiment, the tool takes fairness fully into account. Also, in-office collaboration is widely understood as an important contributor to positively building the culture and progressing in one's career. In an exemplary embodiment, the tool is designed to provide this balance for employees.

Flexibility: In an exemplary embodiment, flexibility is viewed as an essential feature in scheduling. The tool allows users to explore what-if-scenarios, as well as to quickly reschedule rotations when changes occur, such as instances where more desks become available.

Scheduling flexibility is also important for work/life balance, and key for an ability of an organization to attract and retain employees. Further, researchers have found that individuals who had the opportunity to work from home reported substantially higher work satisfaction than a control group, and attrition fell sharply among them—dropping by 50 percent compared to the control group. Additionally, working from home has already shown a positive impact for inclusivity in certain locations where attrition of females was previously higher due to mandated in-office working.

Explainability is built into the model. In an exemplary embodiment, the tool generates reasons for assignment decisions.

In an exemplary embodiment, the tool receives three types of input. The three types of AI-DWS inputs include employee input, manager input, and business constraints.

For the employee input and the manager input, the inputs are collected, and the user enters it into the tool. In an exemplary embodiment, employee preferences may include any one or more of a minimum number of days a week in-office; a maximum number of days a week in-office; out-of-office dates (e.g., holidays or instances of childcare constraints); in-office dates (e.g., a workshop or an important meeting with a client); and/or preferred weekdays in-office (e.g. Julianna prefers to be in the office on Mondays).

In an exemplary embodiment, regarding manager preferences, a manager can add or modify employee preferences. The manager may provide additional input including any one or more of a schedule duration (e.g., a planning period, which may be three weeks at a time); and/or a working group. In an exemplary embodiment, an organization may be considered a team, and a working group is a subset of that team (e.g., working group 1, working group 2). When employees are part of multiple working groups, the tool may aim to assign the employees in the same working groups to be co-located in the office on the same days, to the extent possible.

In an exemplary embodiment, an input to a schedule may also be made by users of the tool, who can adjust any employee/manager preference, such as editing an in-office date for a particular working group.

Business constraints are required inputs to generate a plan, which may include a number of desks allocated to a team. This information may be provided by the business for each team. The business constraint information may incorporate relevant legal requirements, such as, for example, a minimum number of in-office days for a particular individual.

In an exemplary embodiment, a business constraint input to the tool may be processed as either a mandatory, or hard, constraint; or as a preferred, or soft, constraint.

In an exemplary embodiment, mandatory constraints are always respected by the tool. The following preferences are examples of those which may be designated as hard constraints: 1) A number of desks allocated to each team—as a hard constraint, this means the number of employees in the office never exceeds the number of the desks allocated to that team; 2) a minimum number of days in-office; 3) a maximum number of days in-office; and 4) employee days out-of-office, i.e., days the tool ensures employees are not assigned to be in-office.

Infeasibility: In an exemplary embodiment, when all hard constraints cannot be satisfied, the tool determines an infeasible scenario. In this case, the tool 1) displays an explanation for the infeasibility and 2) outlines actions that a user can take to either relax preferences or modify constraints and have the tool rework a solution.

In an exemplary embodiment, preferred constraints (i.e., soft constraints) are the set of preferences that the planner aims to satisfy as much as possible. This means that there might be solutions presented where only a subset of the soft constraints is satisfied. The following employee preferences may be examples of soft constraints: preferred weekdays in-office; and required dates in-office.

Table 1 below lists representative constraints.

TABLE 1
Representative Constraints

| | | Hard/Soft | Further |
|---|---|---|---|
| Constraint Type | Constraint | Constraint | Detail/Example |
| Business | Number of | Hard constraint | This information is |
| | Available Desks | | provided by the business |
| | | | for each team and |
| | | | entered into the tool by |
| | | | the user. Employees |
| | | | scheduled to come to the |
| | | | office can never exceed |
| | | | the number of desks. |
| Employee | Out-of-Office | Hard constraint | Days that employee does |
| | Days | | not wish to work from |
| | | | the office, e.g., holidays |
| | | | or annual leave or work |
| | | | from home days. |
| Employee/Manager | Minimum number | Hard constraint | Employee will never be |
| | of days in the | | assigned to go to the |
| | office | | office fewer days than |
| | | | what they designate as |
| | | | their preference unless |
| | | | tool calculates an |
| | | | infeasible scenario. |
| Employee/Manager | Maximum | Hard constraint | Maximum number is |
| | number of days in | | never exceeded. If |
| | the office | | employee defines 2 days |
| | | | maximum, employee |
| | | | does not go to office for |
| | | | a third day, even if |
| | | | empty desks exist. |
| Manager/Employee | Required dates in- | Soft constraint | This constraint takes |
| | office | | priority over working |
| | | | groups |
| Manager | Working Groups* | Soft constraint | This constraint takes |
| | | | priority over preferred |
| | | | weekdays |
| Employee | Preferred | Soft constraint | If an employee wishes to |
| | weekdays | | come to the office on |
| | | | Mondays but they can go |
| | | | on Tuesdays when the |
| | | | working group will be |
| | | | there, tool assigns |
| | | | Tuesdays. |

Methodology: In an exemplary embodiment, the methodology is implemented as a web-based application. The tool aims to maximize the number of persons scheduled in-office, given constraints, while aiming to accommodate preferences. If all employee preferences cannot be satisfied, the tool satisfies them to the degree possible using an unbiased and fair approach.

In an exemplary embodiment, the rotational scheduling problem is modeled as a maximization problem using a mixed-integer linear programming (MILP) approach. The objective function of the model attempts to maximize the number of people in the workspace, based on a set of constraints.

In an exemplary embodiment, in order to reach the target, the objective function works in three parts and does the following: 1) The first part of the objective function tries to send as many employees as possible to the office on each day, while considering employee preferences for each particular day. In this way the model tries to assign employees in-office on the days that they prefer, or their manager prefers for them. 2) The second part of the objective function tries to send people in the same working group to the office on the same days. 3) The remaining terms in the objective function are subtractions that play a role to (a) relax constraints due to an infeasible solution and (b) balance solutions that are unbalanced for fairness purposes. Each constraint is associated with a weight in the planning model, and the weight determines the priority order of constraints.

In an exemplary embodiment, the problem is maximized subject to a set of constraints, and does the following: 1) ensures number of employees in-office per day does not exceed number of available desks; 2) respects employee/manager constraints for minimum number of days per week; 3) respects employee/manager constraints for maximum number of days per week; 4) optimizes instances of working groups co-located in-office; 5) aims to balance the number of employee days in-office while respecting minimum and maximum days per week, representing the fairness measures built into the model; and 6) aims to balance the number of Fridays an employee goes to the office over the planning period.

In an exemplary embodiment, the tool is designed to produce fair schedules. For example, the tool is designed to weigh the overall balance of employees' in-office days and Fridays not in-office; the tool distributes out-of-office Fridays evenly among staff for the planning period.

In another example, fairness is reflected in instances where there exists a low number of available desks and a high minimum days-per-week in-office requirement. This scenario might be infeasible for a solution. In these cases, when prompted by the user, the algorithm decides which employee preferences should be relaxed. The tool ensures that the adjustment is spread across all resources being scheduled, and prevents the preferences of any one team members from being favored over the preferences of another.

Output: Given a rotational schedule planning period, such as three weeks, a number of desks for a team and other input, the planner aims to return a solution. There are two possible scenarios: a solution exists, and the planner will return this solution; or a solution does not exist, in which case the planner will prompt the user to either change preferences or have the system relax the problem.

If the tool finds a feasible solution to the problem, this means all the hard constraints are met and the soft constraint are satisfied to the extent possible. In this case, the tool generates the following items and displays them on the user interface: 1) a rotational schedule for the team, with the user option to tweak preferences; and 2) a set of metrics for the preferences honored by the tool. In addition, a report can be generated by the user.

Infeasible Scenarios: The tool determines an infeasible scenario if any hard constraints cannot be satisfied. In this case, the user can have the tool relax constraints and rework the output. As an example, infeasibility may occur for only one hard constraint: minimum number of days in the office. In this scenario, there are more people seeking to work in-office than there are available desks in the workspace. In this case: 1) constraints will be returned to the planner and 2) the “minimum number of days in office” hard constraint will be considered a soft constraint. In this aspect, the number of desks and the employee days out-of-office are hard constraints that cannot be relaxed.

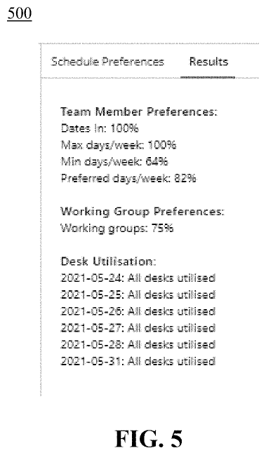

Metrics: The tool can generate any and all metrics based on the constraints and other inputs. Referring to FIG. 5, a screenshot 500 of a user interface displaying such a set of metrics is shown.

The user may continue to modify preferences through the user interface and regenerate results before finalizing the schedule. The schedule and team details are displayed, together with metrics and team member preferences. When satisfied with the schedule, the user can transmit the schedule to a distribution list via email.

In an exemplary embodiment, one objective of the tool is to help users make decisions, and to do so, the users need to understand the output being provided by the tool. Explainability helps users understand how and why the tool achieves its outcome given a set of inputs. This understanding enables trust and also supports users in managing the tool.

After receiving inputs, the tool generates the output and displays the generated output for the user. The output is either a solution or a determination that a solution is infeasible, with suggested next steps. Accordingly, in an exemplary embodiment, the tool provides two types of explanations, one for infeasible scenarios and another for solutions.

Solutions: Explanations for solutions focus on helping users to understand why the inputs resulted in a particular schedule. For example, the tool can inform the user that a working group could not be co-located on a particular day because there were some employees from a different group whose attendance in the office was mandatory.

Infeasible Scenarios: Explanations for infeasible scenarios help users understand why the problem cannot be solved given their inputs. In this case, in an exemplary embodiment, the tool displays alternative scheduling scenarios to be considered by the users. The alternatives present how the infeasible problem can become solvable. For example, the tool may determine that there are not enough desks to satisfy the employee minimum number of days per week requirements, and suggest that the user either increase the number of desks or relax employee requirements.

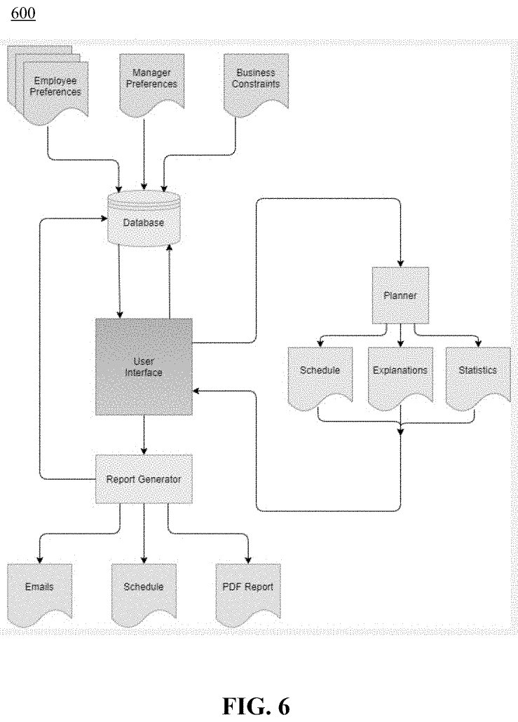

FIG. 6 is a block diagram 600 of a system architecture that is configured to execute a method for maximizing a number of individuals co-located in a workspace for a given set of constraints while providing fairness and flexibility in scheduling, according to an exemplary embodiment.

Referring to FIG. 6, in an exemplary embodiment, the tool is embedded into a web-based application that is usable for dynamically generate rotational schedules for teams. The architecture 600 of the web-based application is shown in FIG. 6. As illustrated, input is received from three modules, sourced from employees, managers and the business. Variables in these modules can be included or excluded as needed, and these modules can be expanded to include more variables.

A planning scenario is defined by the set of input points. Examples include user, employee/manager and business constraints. In an exemplary embodiment, each planning scenario generated by the tool is stored as output in a database in association with a user identification. The stored output includes the schedule, the explanations of the solution and the metrics for constraints met. This information is stored for two main purposes: 1) so that users can retrieve their old planning scenarios and solutions; and 2) so that the data is available for subsequent processing in order to improve AI models.

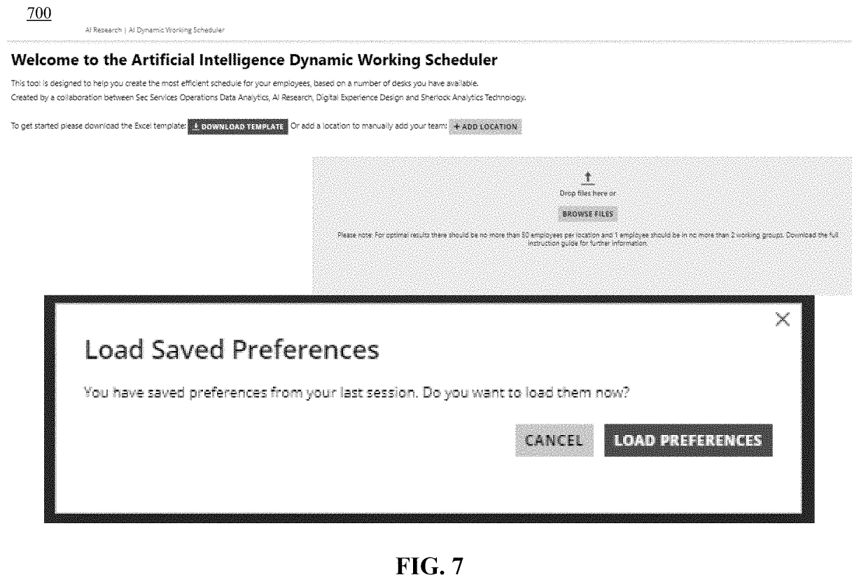

User Interface: FIG. 7 is a screenshot 700 of a user interface displaying a home page and prompt for loading a set of preferences. In an exemplary embodiment, users are prompted to create a schedule by entering the following information for each employee: name, employee system ID (SID), email address, location, and the names of any working groups with which the employee is associated. Alternatively, the user may click to browse and upload a file or load preferences from files that have previously been saved.

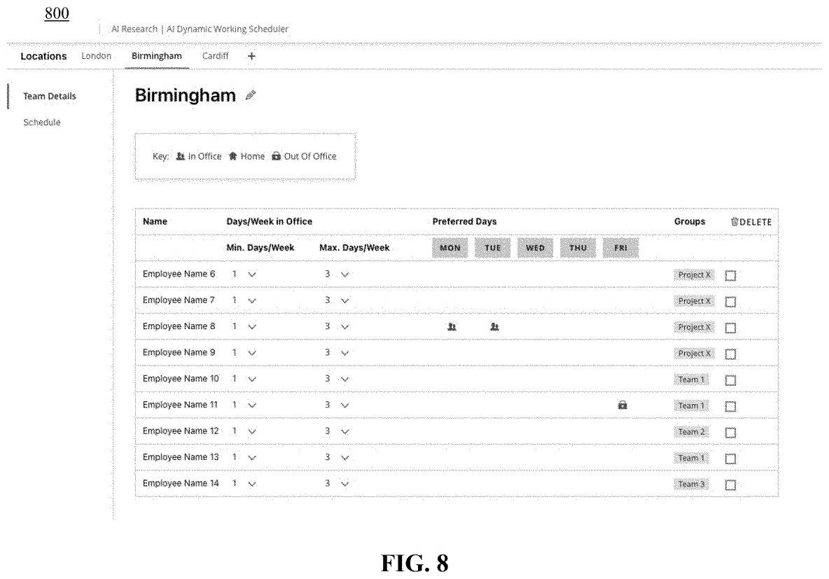

View Stakeholder Preferences: FIG. 8 is a screenshot 800 of a user interface displaying a set of schedules together with preferences. After uploading a file with working group data, the stakeholder (i.e., an employee and/or a manager) preferences display. In an exemplary embodiment, these preferences may be displayed on a Team Details tab. Sample tasks the user can perform on this tab may include the following: 1) click a location to view team details; 2) edit minimum days and maximum days in-office for team members; 3) edit preferred days in office, home and out-of-office for team members; 4) add/delete team members; 5) add/delete working groups; 6) delete locations; and 7) view metrics.

View Rotational Schedule—Schedule tab: In an exemplary embodiment, the user may click the Schedule tab to view the rotational schedules for the working groups in the location. Sample tasks the user can perform on this tab may include the following: 1) view schedule preferences by working group; 2) view “Results” which provide the metrics for the preferences satisfied and desk utilization; 3) upload and download team details; 4) edit number of desks; and 5) email schedule.

Mixed Integer Linear Programming (MILP) Model: In an exemplary embodiment, a dynamic scheduling problem may be formulated as a mixed integer linear programming problem, where E=a set of employees; D=a set of days being planned for; W=a set of weeks being planner for where each wϵW is a set of days in each week of the planning period; Nd=number of desks being planned for; Nf=number of Fridays within the planning period; Ne=number of employees being planned for; Ci,j=a constant value that indicates the preferences of employee iϵE for each day jϵD; Ui=a maximum number of days that each employee iϵE wants to be in the office per week; Li=minimum number of days that each employee iϵE wants to be in the office per week; and T=a set of working groups, where each working group consists of employees who should be in the office at the same time. In addition, the model includes the following binary variables: xi,j=1 if an employee iϵE goes to the office on day jϵD, and otherwise, xi,j=0; and yt,k,j=1 if for each team tϵT, k {2, . . . , |t|} members of that working group go to the office on day jϵD, and otherwise, yt,k,j=0. Further, the model also includes the following integer slack variables: si,w=an integer variable which can get an integer value for each employee iϵE on week wϵ|W|, which helps the problem of remaining feasible in scenarios where employees are not able to meet the minimum days per week constraint; stotal=an integer variable which is greater than the maximum value of si,w for all iϵE on week wϵ|W|; sdj=an integer variable which can get an integer value for each day jϵD, which helps the problem of remaining feasible in cases where the number of employees is less than the number of desks Nd; and bi,w=an integer variable which can get an integer value for each iϵE on week wϵ|W|, which helps balancing the number of days each employee goes to the office on each week.

Regarding Ci,j, based on the preferences of the employees, different values of Ci,j are assigned for each day. If an employee chooses a specific day as “Dates in Office,” the corresponding days will get a value of 10. Also, the days defined as “Preferred Days” will get a value of 3, and the rest of the days will have a value of 1. In addition, any specific dates chosen as “Out of Office Dates” will get a value of 0.

Based on the above, the model may be expressed as follows:

$$Max {\sum }_{i ∈ E , j ∈ D} {C}_{i , j} {x}_{i , j} + {\sum }_{t ∈ T , k ∈ \{ 2 , … , \vert t \vert \} , j ∈ D} {k}^{2} * {y}_{t , k , j} - {\sum }_{i ∈ E , w ∈ \vert W \vert} {s}_{i , w} / ( {L}_{i} + 1 ) - {s}_{total} - {\sum }_{j ∈ D} {sd}_{j} - {\sum }_{i ∈ E , w ∈ W} {b}_{i , w} - {\sum }_{i ∈ E} {f}_{i} \qquad ( 1 )$$

$$subject to : {\sum }_{i ∈ E} {x}_{i , j} + {sd}_{j} = {N}_{d} , j ∈ D \qquad ( 2 )$$

$${\sum }_{j ∈ w} {x}_{i , j} \leq {LI}_{i} , i ∈ E , w ∈ W \qquad ( 3 )$$

$${\sum }_{j ∈ w} {x}_{i , j} + {s}_{i , w} \geq {L}_{i} , i ∈ E , w ∈ W \qquad ( 4 )$$

$${s}_{total} \geq {s}_{i , w} / ( {L}_{i} + 1 ) , i ∈ E , w ∈ W \qquad ( 5 )$$

$${\sum }_{i ∈ t} {x}_{i , j} \geq k * {y}_{t , k , j} , i ∈ T , k ∈ \{ 2 , … , \vert t \vert \} , j ∈ D \qquad ( 6 )$$

$${\sum }_{i ∈ t , k ∈ \{ 2 , … , \vert t \vert \}} {y}_{t , k , j} \leq 1 , t ∈ T , j ∈ D \qquad ( 7 )$$

$$( {N}_{d} * 5 ) / {N}_{e} - {\sum }_{j ∈ w} {x}_{i , j} <= {b}_{i , w} , i ∈ E , w ∈ W \qquad ( 8 )$$

$$- ( {N}_{d} * 5 ) / {N}_{e} + {\sum }_{j ∈ w} {x}_{i , j} <= {b}_{i , w} , i ∈ E , w ∈ W \qquad ( 9 )$$

$$( {N}_{d} * {N}_{f} ) / {N}_{e} - {\sum }_{j ∈ w} {x}_{i , j} <= {f}_{i} , i ∈ E \qquad ( 10 )$$

$$- ( {N}_{d} * {N}_{f} ) / {N}_{e} + {\sum }_{j ∈ w} {x}_{i , j} <= {f}_{i} , i ∈ E \qquad ( 11 )$$

In an exemplary embodiment, the problem has been modeled as a maximization problem. The first part of the objective function, i.e., Equation 1 above, tries to send as many employees as possible to the office on each day, considering also the preference of each employee for each particular day. In this way, the model will try to assign employees to go to the office on the days that they or their manager prefer.

The second part of the objective function tries to send people in the same working group to the office on the same days. The rest of the terms in the objective function are subtractions that 1) play a role when the problem is infeasible and needs to be relaxed; and 2) penalize solutions that are unbalanced, e.g., some employee preferences are always respected and other employee preferences are not.

The objective function is maximized subject to the following set of constraints: 1) Equation 2 above makes sure that the number of employees that are going to the office per day will not exceed the number of available desks. 2) Equation 3 above ensures the employee/manager's constraint on the maximum number of days per week each employee should go to the office. 3) Similarly, Equation 4 above ensures the employee/manager's constraint on the minimum number of days per week each employee should go to the office. 4) Equation 5 above aims to minimize the difference between the minimum days employees should go to the office and the days the model is assigning them, and also spreads this difference across employees in order to produce a fairer schedule. 5) Equations 6 and 7 above aim to send the working groups together as much as possible. 6) Equations 8 and 9 above aim to balance the number of days each employee goes to the office based on the number of available desks. 7) Similarly, Equations 10 and 11 above aim to balance the number of Fridays each employee goes to the office over the planning period.

Accordingly, with this technology, an optimized process for maximizing a number of individuals co-located in a workspace for a given set of constraints while providing fairness and flexibility in scheduling is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating schedules for a plurality of persons within a common workspace, the method being implemented by at least one processor, the method comprising:
receiving, by the at least one processor, a first user input that relates to at least one employee preference;
receiving, by the at least one processor, a second user input that relates to at least one manager preference;
receiving, by the at least one processor, a third user input that relates to at least one business constraint;
generating, by the at least one processor based on the received first, second, and third user inputs, a respective schedule for each corresponding one of the plurality of persons; and
outputting, by the at least one processor, each respective schedule to a user interface for display thereon.

2. The method of claim 1, further comprising generating a set of metrics that corresponds to each of the at least one employee preference.

3. The method of claim 2, wherein the set of metrics includes at least one from among a percentage of employee preferences that are satisfied by the generated schedules, a percentage of manager preferences that are satisfied by the generated schedules, a date-specific office utilization percentage, and a date-specific desk utilization percentage.

4. The method of claim 1, wherein the first user input includes at least one from among a minimum number of days per week in-office, a maximum number of days per week in-office, at least one out-of-office date, and at least one preferred weekday in-office.

5. The method of claim 1, wherein the second user input includes at least one from among a schedule duration and a respective list of employees associated with a corresponding working group.

6. The method of claim 1, wherein the third user input includes at least one from among a respective number of desks allocated to a corresponding working group, a minimum number of days in-office, a maximum number of days in-office, and at least one out-of-office date associated with a particular employee.

7. The method of claim 1, further comprising generating an explanation with respect to the schedules, and outputting the generated explanation to the user interface for display thereon.

8. The method of claim 1, wherein the generating of the schedules comprises applying an artificial intelligence (AI) algorithm that implements a technique based on planning, scheduling, and constraint reasoning in order to model the received user inputs in order to generate the schedules.

9. A computing apparatus for generating schedules for a plurality of persons within a common workspace, the computing apparatus comprising:
a processor;
and
a communication interface coupled to the processor,
wherein the processor is configured to:
receive, via the communication interface, a first user input that relates to at least one employee preference;
receive, via the communication interface, a second user input that relates to at least one manager preference;
receive, via the communication interface, a third user input that relates to at least one business constraint;
generate, based on the received first, second, and third user inputs, a respective schedule for each corresponding one of the plurality of persons; and
output, via the communication interface, each respective schedule to a user interface for display thereon.

10. The computing apparatus of claim 9, wherein the processor is further configured to generate a set of metrics that corresponds to each of the at least one employee preference.

11. The computing apparatus of claim 10, wherein the set of metrics includes at least one from among a percentage of employee preferences that are satisfied by the generated schedules, a percentage of manager preferences that are satisfied by the generated schedules, a date-specific office utilization percentage, and a date-specific desk utilization percentage.

12. The computing apparatus of claim 9, wherein the first user input includes at least one from among a minimum number of days per week in-office, a maximum number of days per week in-office, at least one out-of-office date, and at least one preferred weekday in-office.

13. The computing apparatus of claim 9, wherein the second user input includes at least one from among a schedule duration and a respective list of employees associated with a corresponding working group.

14. The computing apparatus of claim 9, wherein the third user input includes at least one from among a respective number of desks allocated to a corresponding working group, a minimum number of days in-office, a maximum number of days in-office, and at least one out-of-office date associated with a particular employee.

15. The computing apparatus of claim 9, wherein the processor is further configured to generate an explanation with respect to the schedules, and to output the generated explanation to the user interface for display thereon.

16. The computing apparatus of claim 9, wherein the processor is further configured to generate the schedules by applying an artificial intelligence (AI) algorithm that implements a technique based on planning, scheduling, and constraint reasoning in order to model the received user inputs in order to generate the schedules.

17. A non-transitory computer readable storage medium storing instructions for generating schedules for a plurality of persons within a common workspace, the storage medium comprising executable code which, when executed by a processor, causes the processor to:
receive a first user input that relates to at least one employee preference;
receive a second user input that relates to at least one manager preference;
receive a third user input that relates to at least one business constraint;
generate, based on the received first, second, and third user inputs, a respective schedule for each corresponding one of the plurality of persons; and
output each respective schedule to a user interface for display thereon.

18. The storage medium of claim 17, wherein when executed by the processor, the executable code further causes the processor to generate a set of metrics that corresponds to each of the at least one employee preference.

19. The storage medium of claim 18, wherein the set of metrics includes at least one from among a percentage of employee preferences that are satisfied by the generated schedules, a percentage of manager preferences that are satisfied by the generated schedules, a date-specific office utilization percentage, and a date-specific desk utilization percentage.

20. The storage medium of claim 17, wherein when executed by the processor, the executable code further causes the processor to generate an explanation with respect to the schedules, and to output the generated explanation to the user interface for display thereon.
